(19) United States
(12) Patent Application Publication
(10) Pub. No.: US 2026/0194267 A1
(43) Pub. Date: Jul. 9, 2026

(54) THERMOACOUSTIC GENERATOR WITH TWO WORKING FLUIDS

(71) Applicant: PACCAR Inc, Bellevue, WA (US)

(72) Inventors: Benjamin T. Grover, Maple Valley, WA (US); Adrian Murias, Mercer Island, WA (US)

(73) Assignee: PACCAR Inc, Bellevue, WA (US)

(21) Appl. No.: 19/009,574

(22) Filed: Jan. 3, 2025

(51) Int. Cl. F25B 23/00

(52) U.S. Cl. CPC F25B 23/00

(57) ABSTRACT

A thermoacoustic generator includes an enclosure having a first portion and a second portion. The first portion is filled with a first working fluid and the second portion is filled with a second working fluid. The first working fluid may be a gas and the second working fluid may be a liquid. The first portion encloses a heat transfer system configured to generate a pressure wave in the first working fluid, and the second portion encloses a bidirectional turbine. The first portion and the second portion are separated by a flexible barrier that is fixedly attached to an interior surface of the enclosure, thereby preventing the second working fluid from entering the first portion of the enclosure or flowing in a direction of gravity.

### BACKGROUND

Thermoacoustic generators transform heat energy into acoustic (pressure) waves that can be used to generate electricity. In some cases, the acoustic waves are generated within a gas that passes over a turbine to create mechanical power. It is with respect to this general technical environment that aspects of the present disclosure are directed.

### SUMMARY

The disclosure generally relates to a thermoacoustic generator that uses two working fluids having different densities, such as a gas and a liquid. The generator includes an enclosure that is encloses two portions of the thermoacoustic generator. A heat differential is used to cause an acoustic wave to travel through a first working fluid (e.g., a gas) in a first portion of the enclosure. The first working fluid is coupled to a second working fluid (e.g., a liquid) that resides in a second portion of the enclosure via a flexible barrier (e.g., a diaphragm) between the first portion and the second portion of the enclosure, where the flexible barrier is fixedly attached to an interior surface of the enclosure. The acoustic wave is transferred (e.g., transmitted, propagated), via the flexible barrier, between the gas and the liquid, inducing a pressure wave in the liquid. The wave of liquid passes over a bidirectional turbine that is enclosed by the second portion of the enclosure. An end of the second portion of the enclosure is coupled with atmospheric pressure via a second flexible barrier fixedly attached to the walls of the enclosure.

In some examples, the use of flexible barriers fixedly attached to the walls of the enclosure enables some or all of the thermoacoustic generator to be implemented as a linear structure since the flexible barriers prevent the second working fluid from flowing out of (e.g., exiting) the second portion of the enclosure (e.g., flowing in a direction of gravity). In some cases, the two portions of the enclosure, along with the flexible barriers, form a linear structure substantially without corners or bends, with the flexible barriers preventing the second working fluid from flowing in a direction of gravity. Such a structure has several advantages relative to thermoacoustic generators that may use a U-shape to contain a working fluid, including the ability to place the generator in locations that would not be feasible for a U-shaped generator (such as behind the seats of a heavy-duty truck, for example). In addition, a more linear thermoacoustic generator may not lose energy in corners or bends such as may occur in U-shaped generators due to, for example, boundary layer disruptions

In an example, a thermoacoustic generator is described. The thermoacoustic generator includes: an enclosure including: a first portion containing a first working fluid, and a second portion containing a second working fluid; a heat transfer system enclosed in the first portion of the enclosure, the heat transfer system configured to cause a temperature differential in the first working fluid; a turbine enclosed in the second portion of the enclosure; and a first flexible barrier between the first portion and the second portion, where the first flexible barrier is fixedly attached to a surface of the enclosure.

In some examples, the thermoacoustic generator further includes: a second flexible barrier at an end of the enclosure adjacent to the second portion of the enclosure, where the second flexible barrier is fixedly attached to the enclosure.

In some examples, the first flexible barrier and the second flexible barrier prevent the second working fluid from flowing under influence of gravity.

In some examples, the first flexible barrier prevents the second working fluid from entering the first portion of the enclosure and the second flexible barrier prevents the second working fluid from exiting the enclosure.

In some examples, the first working fluid is a gas and the second working fluid is a liquid.

In some examples, the first flexible barrier is a diaphragm configured to transmit pressure waves between the first working fluid and the second working fluid.

In some examples, the heat transfer system includes a first heat exchanger, a second heat exchanger, and a regenerator stack between the first heat exchanger and the second heat exchanger.

In some examples, the first heat exchanger is configured to radiate heat received from a heat source into the first working fluid.

In some examples, the regenerator stack is configured to cyclically store heat from the first working fluid and release heat into the first working fluid.

In some examples, the second heat exchanger is configured to radiate heat received from the first working fluid into an atmosphere around the enclosure.

In some examples, the first portion of the enclosure and the second portion of the enclosure are unitarily formed.

In some examples, the first flexible barrier and second flexible barrier are both fixedly attached to an interior surface of the enclosure.

In some examples, a first longitudinal axis of the first portion and a second longitudinal axis of the second portion are co-linear.

In some examples, the turbine is a bidirectional turbine.

In some examples, the second working fluid is water.

In another example, a vehicle is described. The vehicle includes: an enclosure including: a first portion enclosing a regenerator stack thermally coupled to a heat source of the vehicle, and a second portion enclosing a turbine; a first working fluid in contained in the first portion; a second working fluid contained in the second portion; and a first flexible barrier between the first portion and the second portion, the first flexible barrier fixedly attached to the enclosure.

In some examples, the vehicle further includes the heat source.

In some examples, the heat source includes one of an engine or an exhaust system of the vehicle.

In some examples, the first flexible barrier prevents the second working fluid from entering the first portion of the enclosure.

In another example, a thermoacoustic generator is described. The thermoacoustic generator includes: an enclosure including: a first portion enclosing a heat transfer system; a second portion enclosing a bidirectional turbine; a first working fluid in contained in the first portion, where the heat transfer system is configured to induce a pressure wave in the first working fluid; a second working fluid contained in the second portion, where the second working fluid has a greater density than the first working fluid; a first flexible barrier between the first portion and the second portion, the first flexible barrier fixedly attached to the enclosure; and a second flexible barrier at an end of the enclosure adjacent to the second portion of the enclosure, where the second flexible barrier is fixedly attached to the enclosure.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures:

FIG. 1 depicts a block diagram of a thermoacoustic generator according to an example.

FIG. 2 depicts a block diagram of another thermoacoustic generator according to an example.

FIG. 3 depicts a vehicle that includes a thermoacoustic generator according to an example.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. The following detailed description is, therefore, not to be taken in a limiting sense.

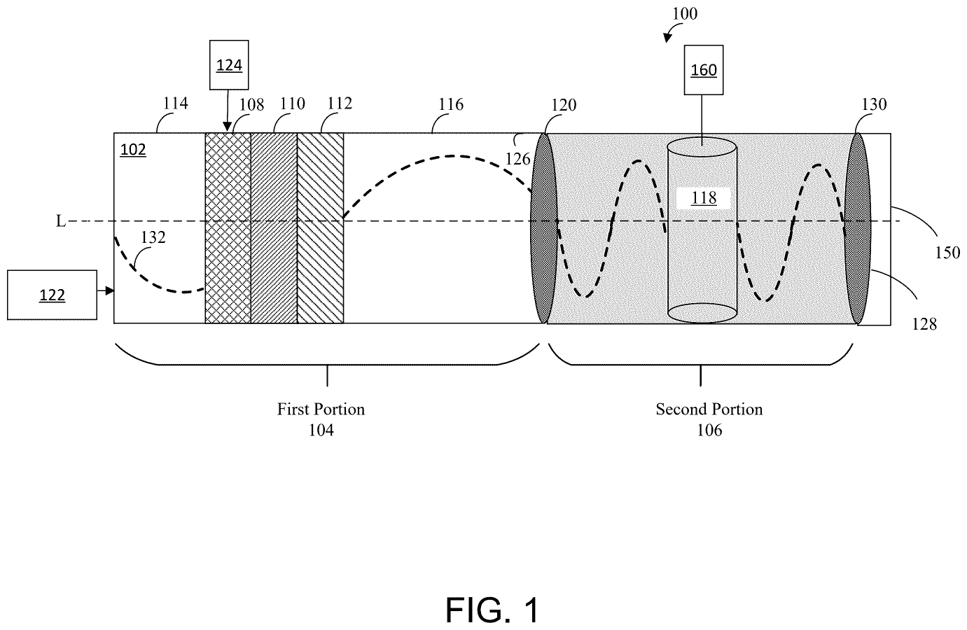

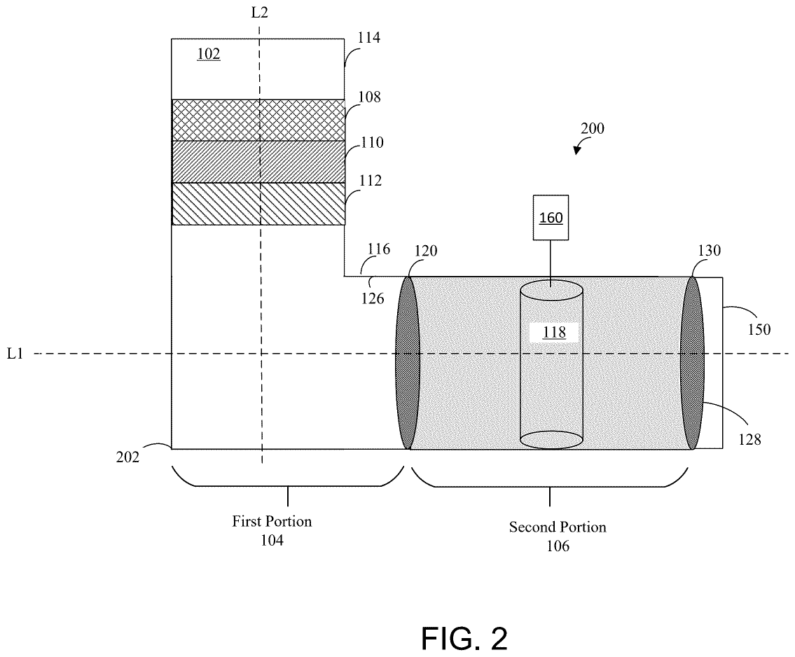

FIG. 1 depicts a thermoacoustic generator 100 having an enclosure 102 that is configured to enclose two (different) working fluids and various hardware elements. The enclosure 102 may be a structure defining a longitudinal axis L. For example, the enclosure may be cylindrical. In other examples, the enclosure 102 may be a different shape (such as a rectangular prism, an ellipsoid, or a shape having another cross-sectional profile). In addition, the outside of the enclosure 102 may have a first cross-sectional profile (e.g., rectangular), while an interior of the enclosure 102 may have a different cross-sectional profile (e.g., cylindrical). Further, as discussed with respect to FIG. 2, for example, the enclosure may include one or more turns or corners. The enclosure 102 may be formed of a rigid or semi-rigid material, such as metal or rigid plastic, such as polyvinyl chloride (PVC). As will be discussed, a flexible barrier 120 (e.g., a first flexible barrier) may be positioned within enclosure 102. Further, an opening at one end 128 of the enclosure 102 may be covered by a flexible barrier 130 (e.g., a second flexible barrier) that is at least partially formed of a flexible material, such as rubber or polytetrafluoroethylene (PTFE). In some examples, the flexible barriers 120 and 130 may each have a rigid perimeter that permits them to be fixedly attached to the enclosure 102. For example, a rigid perimeter of the flexible barriers 120 and 130 may be fixedly attached to an interior surface of the enclosure and/or an exterior surface of the enclosure 102. For example, the flexible barriers 120 and 130 may each comprise a rigid perimeter to which a flexible material is coupled, with the flexible material covering a majority (e.g., at least 70 percent, at least 80 percent, at least 85 percent, at least 90 percent, at least 95 percent, or at least 99 percent) of the cross-sectional area of the interior cavity defined by enclosure 102. In examples, the flexible barriers 120 and 130 may be attached to the enclosure 102 by any suitable method. For example, a rigid portion of flexible barrier 130 may include threading that cooperates with threading on an interior or exterior surface of the enclosure 102 to secure flexible barrier 130 to end 128 of enclosure 102. In other examples, flexible barrier 130 does not include a rigid perimeter, and a flexible material of the flexible barriers 120 and 130 may be directly attached to one or more surface of the enclosure 102 by adhesive or otherwise. Other attachment mechanisms are possible and contemplated.

In addition, thermoacoustic generator 100 may further include an end cap 150 that attaches to the enclosure 102 to protect the flexible barrier 130. For example, if the thermoacoustic generator is installed in a vehicle, it may be advantageous to cover flexible barrier 130 with a rigid end cap 150 to prevent the flexible barrier 130 from being accidentally punctured (e.g., during maintenance of the vehicle or otherwise). In examples, end cap 150 may be attached to enclosure 102 in any suitable manner (e.g., by including cooperative threading on the end cap 150 and the end 128 of the enclosure 102). In examples, end cap 150 may be configured to maintain exposure of the outside of flexible barrier 130 (opposite the interior of the enclosure 102) to atmospheric pressure. For example, end cap 150 may provide rigid structural protection for flexible barrier 130, but may be open to atmospheric pressure within end cap 130 (e.g., through perforation of end cap 130, a grid-like structure of the end cap 130, etc.).

The enclosure 102 defines an interior cavity and references in this application to the enclosure 102 being filled with a fluid shall mean the interior cavity of enclosure 102 being so filled. A first portion 104 of the enclosure 102 contains (e.g., is filled or nearly filled with) a first working fluid and a second portion 106 of the enclosure contains (e.g., is filled or nearly filled with) a second working fluid. In examples, “nearly filled” means at least 70 percent, at least 80 percent, at least 85 percent, at least 90 percent, at least 95 percent, or at least 99 percent filled. The first working fluid may be a first gas or a first liquid, and the second working fluid may be a second gas or a second liquid. In some examples, the second working fluid has a higher density than the first working fluid. For example, the first working fluid may be a gas (e.g., air) and the second working fluid may be a liquid (e.g., water). A first heat exchanger 108, regenerator stack 110, and second heat exchanger 112 are located in (e.g., enclosed within) the first portion 104 of the enclosure and are in contact with the first working fluid. The first heat exchanger 108, regenerator stack 110, and second heat exchanger 112 may be referred to collectively as a heat transfer system, and may be configured to induce a pressure wave in the first working fluid. The regenerator stack 110 is located between the first heat exchanger 108 and second heat exchanger 112. The first portion 104 of the enclosure may include a first cavity 114 adjacent to the first heat exchanger 108 and a second cavity 116 adjacent to the second heat exchanger 112. The first cavity 114 may be coupled with a pressurization system 122 (e.g., a compressor) configured to pressurize the first working fluid. In other examples, the first cavity 114 may be pressurized and sealed during manufacture, and no ongoing pressurization system 122 may be required.

The first heat exchanger 108 may be thermally coupled to a heat source 124 and configured to dissipate heat absorbed from the heat source 124 into the first working fluid, such as by including thermally conductive fins, a thermally conductive honeycomb structure, or other thermally conductive structures having relatively large surface areas suitable for dissipating or absorbing heat. The second heat exchanger 112 may be thermally coupled to an atmosphere or liquid surrounding the thermoacoustic generator 100 and may have a structure similar to that of the first heat exchanger 108. The second heat exchanger 112 may be configured to dissipate heat absorbed from the first working fluid into the atmosphere, thereby cooling the first working fluid. The regenerator stack 110 is configured to store and release heat (e.g., by converting the mechanical energy of the pressure wave to heat, and converting heat to a pressure wave) as the first working fluid flows through the regenerator stack 110 between the first heat exchanger 108 and the second heat exchanger 112. In some examples, the regenerator stack is a porous material such as a wire mesh screen, a stack of wire mesh screens, one or more stacks of tubes, and/or one or more ceramic structures having pores. In examples where the thermoacoustic generator 100 is incorporated into a vehicle, heat source 124 may comprise an engine or one or more parts of an exhaust system of an engine from which heat energy is desired to be scavenged.

A bidirectional turbine 118 is located in the second portion 106 of the enclosure and is in contact with the second working fluid. The first portion 104 and the second portion 106 are separated by a first flexible barrier 120 that is fixedly attached to (e.g., an inner surface 126 of) the enclosure. An end 128 of the second portion 106 is formed of a second flexible barrier 130 that is fixedly attached to (e.g., the inner surface 126 of) the enclosure 102. As discussed, the end 128 of the enclosure (e.g., the second flexible barrier 130) may be exposed to atmospheric pressure.

In operation, the first heat exchanger 108 heats the pressurized first working fluid and the second heat exchanger 112 cools the first working fluid, thereby creating a temperature differential in the first working fluid across the first heat exchanger 108 and second heat exchanger 112, which causes the fluid to flow through the regenerator stack and develops a pressure wave 132 in the first working fluid as the first working fluid moves from the higher pressure (hotter) region to the lower pressure (cooler) region of the enclosure 102. The pressure wave 132 in the first working fluid is transmitted to the second working fluid via the first flexible barrier 120, causing the pressure wave to continue to be formed in the second working fluid. The pressure wave in the second working fluid passes over the bidirectional turbine 118, which causes the bidirectional turbine 118 to spin and produce mechanical energy. The bidirectional turbine 118 is self-rectifying in that it spins a rotor shaft in the same direction regardless of the direction of flow of the second working fluid. The rotor shaft may be mechanically connected (directly or through one or more gears or linkages) to a generator 160, for example, to convert mechanical energy of the rotor shaft into electrical energy that can be stored and/or used. In examples, generator 160 may be configured within enclosure 102 or outside of enclosure 102. A standing wave is formed in the first working fluid and second working fluid as a temperature differential is maintained by the heat exchangers 108, 112 and regeneration stack 110. The first flexible barrier 120 prevents the first working fluid from mixing with the second working fluid and prevents both working fluids from flowing in a direction of) gravity while allowing transmission (propagation) of the pressure wave between the two working fluids. The second flexible barrier 130 prevents the second working fluid from exiting the enclosure 102. For example, the second flexible barrier prevents the second working fluid from flowing under the influence of (e.g., in a direction of) gravity. In examples, fixedly attaching the flexible barriers 120 and 130 to the enclosure 102 permits the use of enclosures 102 having shapes that are not required to maintain the first or second fluids in place by virtue of gravity. This may be useful, for example, in vehicle applications, where the geometry of thermoacoustic generator 100 may need to accommodate various other parts of the vehicle in extremely confined spaces.

In the example of FIG. 1, the longitudinal axes of the first portion 104 and second portion 106 are co-linear (e.g., the enclosure 102 is a cylindrical structure). In other examples, the second portion 106 may have a first longitudinal axis and the first portion 104 may have at least a second longitudinal axis that is not co-linear (e.g., having curves or corners), such as shown in the non-exclusive example of FIG. 2.

FIG. 2 depicts another thermoacoustic generator 200 that includes the elements of the thermoacoustic generator 100 of FIG. 1, which will not be repeated here for brevity. In the example of FIG. 2, the second portion 106 of the enclosure and a section of the first portion 104 of the enclosure share at least one longitudinal axis L1. A second section of the first portion 104, however, also defines a second longitudinal axis L2 that is not colinear with the longitudinal axis L1 (e.g., first portion 104 may include a corner 202 or a bend). Other shapes of the enclosure 102 are possible and contemplated. For example, the second portion 106 may also be non-linear.

In the examples shown in FIGS. 1 and 2, the enclosure 102 is unitarily formed (e.g., is a single piece). In some examples, the enclosure 102 may comprise multiple pieces joined together by any suitable method (e.g., welding, adhesive, cooperative threading, etc.). For example, the first portion 104 and second portion 106 of enclosure 102 may be part of a unitary structure (as depicted) or may be separate pieces that are joined, e.g., at the point at which flexible barrier 120 is situated. For example, flexible barrier 120 may be attached to one of first portion 104 or second portion 106, and then first portion 104 and second portion 106 may be attached to each other to form enclosure 102. Other configurations are possible and contemplated.

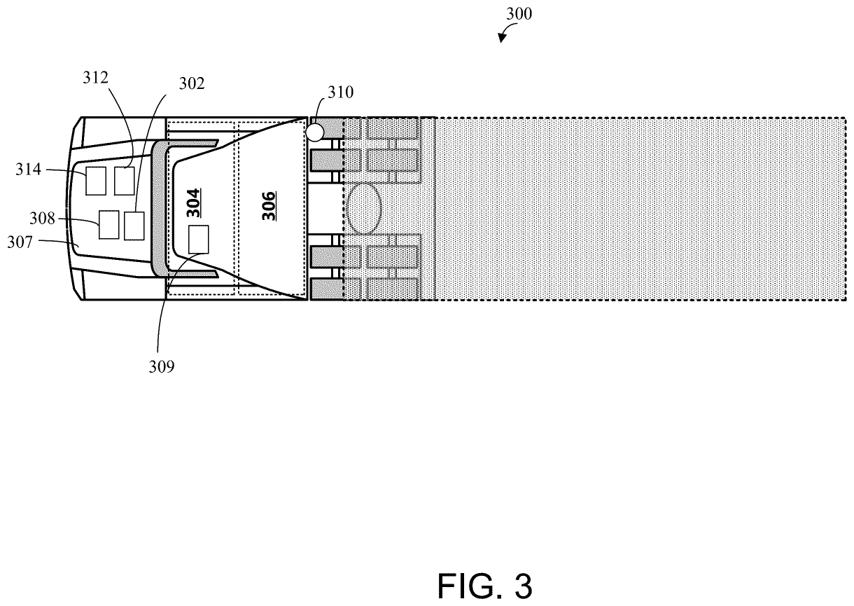

FIG. 3 depicts a top-down conceptual view of a vehicle 300 that include a thermoacoustic generator 302. Thermoacoustic generator 302 may be similar or the same as thermoacoustic generator 100 and/or thermoacoustic generator 200. In some examples, the vehicle 300 is a heavy-duty truck, such as a Class 8 truck. For instance, the vehicle 300 may include a cab compartment 304 and a sleeper compartment 306 attached to, or integrated with, the cab compartment 304. It will be appreciated that aspects of the disclosed subject matter may have wide application and, therefore, may be suitable for use with any type of vehicle, such as passenger vehicles, motorcycles, buses, light, medium, and heavy-duty vehicles, trains, boats, yachts, motor homes, etc.

The vehicle 300 includes one or more thermoacoustic generator 302, which may be an example of thermoacoustic generator 100 or 200. The thermoacoustic generator 302 is thermally coupled with a heat source of the vehicle, such as with an internal combustion engine 308, vehicle computer 309, and/or an exhaust system 310 of the vehicle 300. In the example of FIG. 3, the thermoacoustic generator 302 is located inside the engine compartment 307 of the vehicle 300, in close proximity to the engine 308. As will be appreciated, one or more thermoacoustic generator(s) 302 may be positioned in other areas of the vehicle 300, such as in the cab compartment 304 (e.g., in the case when the vehicle computer 309 serves as a heat source for the thermoacoustic generator 302). In other examples, the thermoacoustic generator 302 may be located elsewhere in the vehicle, such as to be closer to (and thermally coupled with) a portion of the exhaust system 310 of the vehicle (e.g., when the exhaust system 310 serves as the heat source for the thermoacoustic generator 302). The vehicle 300 further may include one or more battery 314 coupled to a generator 312 (e.g., a traditional generator rather than a thermoacoustic generator). The generator 312 is coupled to an output of the thermoacoustic generator 302 (e.g., a rotor shaft) and may be configured to convert mechanical energy generated by the bi-directional turbine into electrical energy that is then captured by battery 314. In some examples, multiple thermoacoustic generators 302 are provided in vehicle 300 near different heat sources. In examples, one or more additional corresponding generators 312 and/or batteries 314 may also be provided.

The description and illustration of one or more aspects provided in this application are intended to provide a thorough and complete disclosure of the full scope of the subject matter to those skilled in the art and are not intended to limit or restrict the scope of the invention as claimed in any way. The aspects, examples, and details provided in this application are considered sufficient to convey possession and enable those skilled in the art to practice the best mode of the claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure.

We claim:

1. A thermoacoustic generator, comprising:
an enclosure comprising:
a first portion containing a first working fluid, and
a second portion containing a second working fluid;
a heat transfer system enclosed in the first portion of the enclosure, the heat transfer system configured to cause a temperature differential in the first working fluid;
a turbine enclosed in the second portion of the enclosure; and
a first flexible barrier between the first portion and the second portion, wherein the first flexible barrier is fixedly attached to a surface of the enclosure.

2. The thermoacoustic generator of claim 1, further comprising:
a second flexible barrier at an end of the enclosure adjacent to the second portion of the enclosure, wherein the second flexible barrier is fixedly attached to the enclosure.

3. The thermoacoustic generator of claim 2, wherein the first flexible barrier and the second flexible barrier prevent the second working fluid from flowing under influence of gravity.

4. The thermoacoustic generator of claim 2, wherein the first flexible barrier prevents the second working fluid from entering the first portion of the enclosure and the second flexible barrier prevents the second working fluid from exiting the enclosure.

5. The thermoacoustic generator of claim 1, wherein the first working fluid is a gas and the second working fluid is a liquid.

6. The thermoacoustic generator of claim 1, wherein the first flexible barrier is a diaphragm configured to transmit pressure waves between the first working fluid and the second working fluid.

7. The thermoacoustic generator of claim 1, wherein the heat transfer system includes a first heat exchanger, a second heat exchanger, and a regenerator stack between the first heat exchanger and the second heat exchanger.

8. The thermoacoustic generator of claim 7, wherein the first heat exchanger is configured to radiate heat received from a heat source into the first working fluid.

9. The thermoacoustic generator of claim 7, wherein the regenerator stack is configured to cyclically store heat from the first working fluid and release heat into the first working fluid.

10. The thermoacoustic generator of claim 7, wherein the second heat exchanger is configured to radiate heat received from the first working fluid into an atmosphere around the enclosure.

11. The thermoacoustic generator of claim 1, wherein the first portion of the enclosure and the second portion of the enclosure are unitarily formed.

12. The thermoacoustic generator of claim 1, wherein the first flexible barrier and second flexible barrier are both fixedly attached to an interior surface of the enclosure.

13. The thermoacoustic generator of claim 1, wherein a first longitudinal axis of the first portion and a second longitudinal axis of the second portion are co-linear.

14. The thermoacoustic generator of claim 1, wherein the turbine is a bidirectional turbine.

15. The thermoacoustic generator of claim 1, wherein the second working fluid is water.

16. A vehicle comprising:
an enclosure comprising:
a first portion enclosing a regenerator stack thermally coupled to a heat source of the vehicle, and
a second portion enclosing a turbine;
a first working fluid in contained in the first portion;
a second working fluid contained in the second portion; and
a first flexible barrier between the first portion and the second portion, the first flexible barrier fixedly attached to the enclosure.

17. The vehicle of claim 16, further comprising:
the heat source.

18. The vehicle of claim 17, wherein the heat source comprises one of an engine or an exhaust system of the vehicle.

19. The vehicle of claim 16, wherein the first flexible barrier prevents the second working fluid from entering the first portion of the enclosure.

20. A thermoacoustic generator comprising:
an enclosure comprising:
a first portion enclosing a heat transfer system;
a second portion enclosing a bidirectional turbine;
a first working fluid in contained in the first portion, wherein the heat transfer system is configured to induce a pressure wave in the first working fluid;
a second working fluid contained in the second portion, wherein the second working fluid has a greater density than the first working fluid;
a first flexible barrier between the first portion and the second portion, the first flexible barrier fixedly attached to the enclosure; and
a second flexible barrier at an end of the enclosure adjacent to the second portion of the enclosure, wherein the second flexible barrier is fixedly attached to the enclosure.
